(19) United States
(12) Patent Application Publication
(10) Pub. No.: US 2011/0034713 A1
(43) Pub. Date: Feb. 10, 2011

(54) Ortho-metalated, chelate-stabilized benzylamines of the rare-earth metals (RE) Ar3RE

(76) Inventors: Jörg Sundermeyer, Marburg (DE); Alexander Petrov, Braunschweig (DE); Oliver Thomas, Koln (DE)

Correspondence Address: CLARK & BRODY, 1700 Diagonal Road, Suite 510, Alexandria, VA, 22314, US

(21) Appl. No.: 12/745,057

(22) PCT Filed: Nov. 25, 2008
(86) PCT No.: PCT/DE08/01941

§ 371 Date: Oct. 22, 2010

(30) Foreign Application Priority Data
Nov. 28, 2007 (DE) 10 2007 057 586.8

(51) Int. Cl. C07F 5/00

(52) U.S. Cl. 556/1

(57) ABSTRACT

The present invention describes homoleptic, ortho-metalated, chelate-stabilized benzylamine complexes of the rare-earth metals. The rare-earth metals are selected from Sc, Y, La, Ce, Pr, Nd, Pm, Sm, Eu, Gd, Tb, Dy, Ho, Er, Tm, Yb, Lu. In the complexes according to the present invention, at least one benzylic proton of the benzylamine ligand is replaced by an alkyl or aryl group. Such complexes are preferred in which both benzylic protons of the benzylamine ligand are replaced by an alkyl- or aryl group. The complexes according to the present invention are produced by reaction of chelate-stabilized rare-earth metal halides with ortho-lithiated aryl ligands at room temperature under inert gas atmosphere. The complexes according to the present invention are thermally stable and suitable for being used as catalysts for the hydroamination of olefins.

The present invention describes homoleptic, ortho-metalated, chelate-stabilized benzylamine complexes of the rare-earth metals. Hereby, at least one benzylic proton of the benzylamine ligand is replaced by an alkyl or aryl group. The complexes according to the present invention are produced by reaction of chelate-stabilized rare-earth metal halides with ortho-lithiated aryl ligands. The complexes according to the present invention are thermally stable and suitable for being used as catalysts for the hydroamination of olefins.

### DESCRIPTION AND INTRODUCTION TO THE GENERAL AREA OF THE INVENTION

The present invention at hand concerns the areas of rare-earth metal chemistry, coordination chemistry, metal organyls and polymerisation catalysts.

### STATE OF THE ART

The addition of amines RR′HH to olefins (hydroamination) runs only via suitable catalysts. One of the greatest challenges is the increase of the catalyst efficiency, in particular, in the intermolecular variant. An efficient and thermally stable catalyst would be economically most interesting.

There is great interest of the users in laboratories and the chemical industry in RE organyls which are, although suitable for being stored in solution, highly reactive. This goal has not yet been achieved: Whereas phenyllithium (PhLi), for instance, is a storable, commercially available, very appropriate metalation reagent, compounds [(RE)Ph₃(THF)₃] (RE=Y, La, Ce, Sm) are, for instance, instable even at deep temperatures; but would be relatively cost-efficient and would have a high application potential as transmetalation reagents and catalyst precursors.

Obviously, only a few RE compounds based on the ligand N,N-dimethylbenzylamine are known. These are in particular, those RE trisaryls whose cation possesses a relatively small ion radius. Sc and Lu possess the smallest ion radius (Hollemann Wiberg, Lehrbuch der Anorganischen Chemie, 102nd edition, W. de Gruyter 2007).

Due to their thermal instability and tendency for decomposition at room temperature only ortho-lithiated tris-[N,N dimethylbenzylamine] complexes of Y, Sc, Er, Yb and Lu are known today (Organometallics 1985, 4, 1440-1444; Organometallics 1984, 3, 939-941; J. Am. Chem. Soc., 1978, 100, 8068-8073; Inorg. Synth. 1989, 26, 150et seqq.; J. Organomet. Chem. 1989, 364, 79-86) A person skilled in the art also knows ortho-lithiated complexes of some further N,N-dimethylbenzylamine derivatives (Acta Chem. Scand. 1963, 17, 1735-1742; J. Am. Chem. Soc., 1928, 50, 1152; Chem. Ber. 1941, 74B, 982-986; Chem. Eur. J. 2005, 11, 253-261; Tetrahedron, 1989, 45, 569-578; Organometallics 2000, 19, 206; Bull. Chem. Soc. Jpn. 1999, 72, 1879). RE aryls of these substituted derivatives are completely unknown.

As is well known, the deprotonation of racemic and chiral [1-(dimethylamino)ethyl]benzene takes place exclusively in ortho-position of the aromatic ring. The work group van Koten, in particular, has described numerous organic reactions of [1-(dimethylamino)ethyl]benzene with electrophiles [references: a) G. van Koten, J. T. B. H. Jastrzebski, J. G. Noltes, W. M. G. F. Pontenagel, J. S. Kroon, A. Spek, J. Am. Chem. Soc. 1978, 100, 5021. b) C. M. P. Kronenburg, E. Rijnberg, J. T. B. H. Jastrzebski, H. Kooijman. A. Spek, G. van Koten, Eur. J. Org. Chem. 2004, 153. c) C. M. P. Kronenburg, E. Rijnberg, J. T. B. H. Jastrzebski, H. Kooijman. M. Lutz, A. Spek, R. Gossage, G. van Koten, Chem. Eur. J. 2005, 11, 253]. Another lithium aryl, based on the precursor N,N-dimethylcumylamine—2-(N,N,α,α-tetramethyl-aminomethyl)-phenyllithium (3-Li)—has been generated in situ for the first time by a bromine-lithium-exchange of the respective ortho-bromine-aryl with n-BuLi and used in a consecutive reaction [references: a) M. Asakura, M. Oki, S. Toyota, Organometallics 2000, 19, 206. b) S. Toyota, M. Asakura, T. Futawaka, M. Oki, Bull. Chem. Soc. Jpn. 1999, 72, 1879]. We have achieved the synthesis of N,N-dimethylcumylamine-Li through ortho-metalation with t-BuLi at room temperature in pentane. The product N,N-dimethylcumylamine-Li can be isolated at −30° C. by crystallization in 65% yield. It was possible to obtain monocrystals from ether.

Ortho-metalated benzylamines with R1=R2=H have already been used occasionally as ligands in the RE organometallic chemistry of small cations (e.g. Sc, Lu) [L. E. Manzer, J. Am. Chem. Soc. 1978, 100, 8068-8073. b) A. L. Wayda, Organometallics 1984, 3, 939-941. c) A. L. Wayda, Organometallics 1985, 4, 1440-1444]. In only a few cases, the products have been characterized by crystal structure analysis, since compounds with R¹=R²=H are, in particular bigger cations, thermally instable.

The ligand complexes known so far are subject to thermal decomposition due to a H shift:

Thermal decomposition path using the example of the N,N-dimethylbenzylamine ligand complexes Ln(dmba)₃ known in literature:

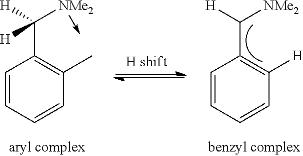

The cost-efficient direct production of C,N-chelate-stabilized, ortho-metalated tris-aryl RE compounds would be, however, of great interest. The present invention overcomes the disadvantages in the state of the art, providing novel, ortho-metalated benzylamine complexes of the rare-earth metals and methods for their production. In the case of the ortho-metalated benzylamines according to the present invention, the decomposition path is blocked, so that they are storable for a long time.

### AIM

It is the aim of the invention to provide novel ortho-metalated benzylamine complexes of the rare-earth metals, as well as methods for their production.

### ACHIEVEMENT OF THIS AIM

The aim to provide novel ortho-metalated benzylamine complexes of the rare-earth metals, as well as methods for their production is achieved according to the present invention by homoleptic complexes according to formula (I):

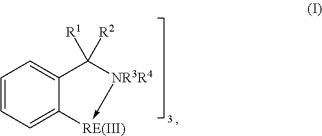

wherein
   RE represents a rare-earth metal selected from Sc, Y, La, Ce, Pr, Nd, Pm, Sm, Eu, Gd, Tb, Dy, Ho, Er, Tm, Yb, Lu,
   R¹ and R² are selected, independent of one another, from hydrogen, a linear or branched alkyl group with 1 to 10 carbon atoms, or an aryl group
   or
   R¹ and R² together stand for 1,ω-alkyldiyl group, selected from 1,4-butandiyl or 1,5-pentandiyl,
   R³ and R⁴ are selected, independent of one another, from a linear or branched alkyl group with 1 to 10 carbon atoms, an aryl group or a trialkylsilyl group —SiR⁵, wherein R⁵ represents a linear or branched alkyl group with 1 to 10 carbon atoms,
and wherein
at least one of both residues R¹ and R² represents a group different from hydrogen.

Surprisingly, it has been found that the undesired thermal instability of the trisaryl compounds decreases drastically, if at least one of the substitutes R¹ and R² does not represent a hydrogen atom. The substitution of one benzylic proton by an alkyl or aryl group already provides for an increased thermal stability which is even more significant if both protons are substituted.

The metals Sc, Y and La from the third group of the Periodic Table, as well as the lanthanoids, are understood under the term “rare-earth metals” in the present invention. On one hand, lanthanum (La) is a metal of the third group. On the other, it is also the first representative of the group of the 4f elements named after it, namely the lanthanoids. In the frame of the present invention, La is classified as belonging to the third group, and under “lanthanoids” which represent the central atoms of the complexes according to the present invention, the metals Ce, Pr, Nd, Pm, Sm, Eu, Gd, Tb, Dy, Ho, Er, Tm, Yb and Lu are understood.

If R¹, R², R³, R⁴ and/or R⁵ stand independently of one another for an alkyl group, the latter is preferably selected from methyl, ethyl, n-propyl, isopropyl, n-butyl, 2-butyl, tert.-butyl.

If R¹, R², R³ and R⁴ stand independently of one another for an alkyl group, the latter is preferably a phenyl group.

In a preferred embodiment R¹ and R² are selected, independently of one another, from a linear or branched alkyl group with 1 to 10 carbon atoms and an aryl group.

In a further preferable practical embodiment, R¹ and R² together stand for 1,ω-alkyldiyl group, selected from 1,4-butandiyl and 1,5-pentandiyl.

In the frame of the present invention, it has been found that the thermal instability of the benzylamines of the rare-earth metals known so far is due to the fact that, in particular with RE metals having a larger ion radius, an RE benzyl anion is a little more stable than an RE aryl anion. Thus, a prototropic shift of the benzylic proton to the aryl anion should occur, most notably if a particularly acidic secondary benzylic proton, such as ligands of the type of [1-(dimethylamino)ethyl] benzene, is present.

Thus, for the first time with the present invention, RE compounds are described in which either R¹=H and R²≠H or both R¹ and R²≠H.

It was found that the first ones possess a significantly increased thermal stability, as compared to the instable and, thus, until now unknown derivatives with R¹=R²=H and that in particular the latter provide, with R¹ and R²≠H, crystalline trisaryls which are stable at room temperature, especially for large cations RE=Nd, Sm, which otherwise eluded this synthesis strategy.

By substitution of at least one of the two benzylic protons, preferably both benzylic protons R¹ or R², respectively, by an alkyl or aryl group, respectively, one of the possible decomposition pathways, the prototropic shift (H shift) of an aryl complex to a benzyl complex, is rendered more difficult or is even completely blocked.

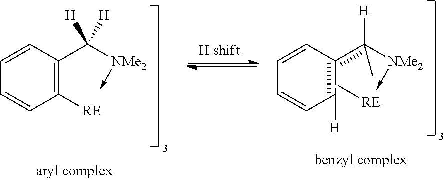

Hereby, Me stands for a methyl group.

It is also in accordance with this assumption that some of the aryl complexes known so far with R¹=R²=H decompose in toluene (as benzylic CH acidic solvent and substrate).

The aim of providing a method for the production of the complexes according to the present invention is achieved, according to the present invention, with a method comprising the steps
addition of 3 equivalents of the ortho-lithiated aryl ligand to a suspension of 1 equivalent of the anhydrous RE halide in an absolute ether at room temperature and under an inert gas atmosphere,
stirring for 1 hour,
isolation and purification of the homoleptic complex according to the present invention.

The method according to the present invention is carried out at room temperature under an inert gas atmosphere and with preheated glassware.

The rare-earth metal halide (RE halide) is a fluoride, chloride, bromide or iodide, wherein chlorides are preferred.

Argon, helium, nitrogen, for instance, and mixtures of these gases are suitable as inert gas. Argon is preferred.

The ether is selected from diethylether, THF, dimethylether and dimethoxyethane (DME).

Isolation and purification of the complexes according to the present invention can, for instance, take place after completed stirring and reduction to dryness and taking up the remainder in toluene (abs.) and filtering over Celite. The solvent is removed and the remaining substance is dissolved in hexane (abs.) under slight heating. Immediate crystallization occurs after short cooling.

These compounds according to the present invention are suitable for being used as catalysts for the hydroamination of olefins. The particular advantage of thermally stable catalysts is their long life cycle (high turnover number) and the possibility of increasing the reaction rate (turnover frequency) by rising the temperature. Furthermore, the use of complexes of RE metals such as Nd, Sm and Gd, for which no trisaryls have been described so far due to their thermal sensitivity, as efficient hydroamination catalysts is possible for the first time.

### EMBODIMENTS

### Embodiment 1

### Synthesis of the N,N dimethylcumylamine 3

The synthesis of the cumylamine was carried out according to literature procedures. (J. of org. chem. 2007, 72, 9, 3193-3206, Supporting Informations). Methylation took place according to the Method of ESCHWEILER-CLARKE. To 29.6 mL of concentrated formic acid (0.784 mol, 8 eq), 16 g of the cumylamine (0.098 mol, 1 eq) was slowly added dropwise at 0° C. To the reaction mixture 34.2 mL of 37% aqueous formaldehyde (0.323 mol, 3.3 eq) was added and heated to 70° C. The occurring gas formation was monitored by means of a bubble counter. After the completion of the reaction, the mixture was cooled and alkalified with sodium hydroxide. The aqueous solution was extracted with 3 times 80 mL Et₂O; the organic phase was dried with MgSO₄ and the solvent was removed. The resulting crude product was purified by distillation. (81-83° C., 7 mm Hg).

Yield: 12.2 g/76%

### Embodiment 2

### Lithiation of the N,N-dimethylcumylamine 3

To a solution of 12.2 g N,N-dimethylcumylamine (0.075 mol, 1 eq) and 250 mL hexane (abs.), 60 mL of a 1.5 molar tBuLi solution in pentane (0.090 mol, 1.2 eq) was slowly added. The reaction mixture was stirred for 48 h at room temperature. After filtration and washing with 30 mL hexane a weakly yellowish solid was obtained.

Yield: 7.5 g/60%

### Embodiment 3

### Synthesis [Y(C₆H₄CH₂N(CH₃)₂)₃]

Comparative sample, known compound, refer to Organometallics 2004, 23, 2601-2612.

### NMR

¹H-NMR (300 MHz, C₆D₆): δ=2.15 (s, 6H), 3.44 (s, 2H), 6.96 (d, 1H), 7.25 (dt, 1H), 7.34 (t, 1H), 8.19 (d, 1H) ppm.

The crystal structure is shown in FIG. 1.

### Embodiment 4

### Synthesis of [Y(C₆H₄CH(CH₃)N(CH₃)₂)₃]

The synthesis was carried out according to the general instruction according to the present invention.

### NMR

¹H-NMR (300 MHz, C₆D₆): δ=1.20 (d, 3H), 2.5 (sb, 6H), 3.19 (sb, 1H), 7.00 (t, 1H), 7.25 (dt, 1H), 7.34 (t, 1H), 8.32 (sb, 1H) ppm.

CHN analysis

| | calculated | found |
|---|---|---|
| N | 7.88 | 7.85 |
| C | 67.53 | 66.98 |
| H | 7.93 | 7.84 |

### Embodiment 5

### Synthesis of [Dy(C₆H₄CH(CH₃)N(CH₃)₂)₃]

The synthesis was carried out according to the general instruction according to the present invention.

CHN analysis

| | calculated | found |
|---|---|---|
| N | 6.92 | 6.81 |
| C | 59.34 | 58.69 |
| H | 6.97 | 6.89 |

### Embodiment 6

### Synthesis of [Nd(C₆H₄CH(CH₃)N(CH₃)₂)₃]

The synthesis was carried out according to the general instruction according to the present invention.

CHN analysis

| | calculated | found |
|---|---|---|
| N | 7.13 | 6.84 |
| C | 61.18 | 58.91 |
| H | 7.19 | 7.00 |

The crystal structure is shown in FIG. 2.

### Embodiment 7

### Synthesis of [Sm(C₆H₄C(CH₃)₂N(CH₃)₂)₃]

The production was carried out according to the general instruction according to the present invention.

CHN analysis

| | calculated | found |
|---|---|---|
| N | 6.60 | 6.49 |
| C | 62.21 | 61.18 |
| H | 7.59 | 7.92 |

The crystal structure is shown in FIG. 3.

### Embodiment 8

### Synthesis of [Gd(C₆H₄C(CH₃)₂N(CH₃)₂)₃]

The synthesis was carried out according to the general instruction according to the present invention.

CHN analysis

| | calculated | found |
|---|---|---|
| N | 6.52 | 6.45 |
| C | 61.55 | 61.05 |
| H | 7.51 | 7.40 |

### Embodiment 9

### Catalytic Experiments for Hydroamination

The experiments were carried out on an NMR scale. As an example, the catalytic activity of the compounds [Y(C₆H₄CH₂N(CH₃)₂)₃] (known comparative sample), [Y(C₆H₄CH(CH₃)N(CH₃)₂)₃] (new) and [Gd(C₆H₄C(CH₃)₂N(CH₃)₂)₃] (new) was tested.

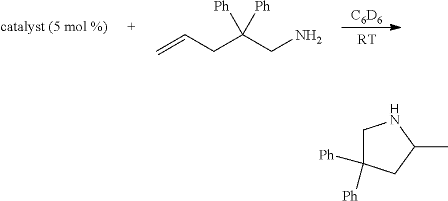

In a glove box, 5 mol % of the catalyst was added to a solution of the substrate in D₆-benzene. The time measurement was started upon addition of the substrate. The reaction progress was monitored at 25° C.

### Results:

| | Quantitative | |
|---|---|---|
| | conversion after | TOF |
| [Y(C₆H₄CH₂N(CH₃)₂)₃] | 46 min | 26.6 |
| [Y(C₆H₄CH(CH₃)N(CH₃)₂)₃] | 21 min | 57.1 |
| [Gd(C₆H₄C(CH₃)₂N(CH₃)₂)₃] | 15 min | 80.0 |

These experiments can be considered as proof of concept for the fact that the claimed compounds with substitutes R1 and R2 unequal to H:

1) yield catalysts with significantly higher activity (entry 2, Y complex).
2) are thermally more stable, so that catalytically effective rare-earth metal complexes are also present (e.g. Gd), for which no equivalent with R¹=R²=H exists so far (entry 3).

### FIGURE LEGENDS

FIG. 1

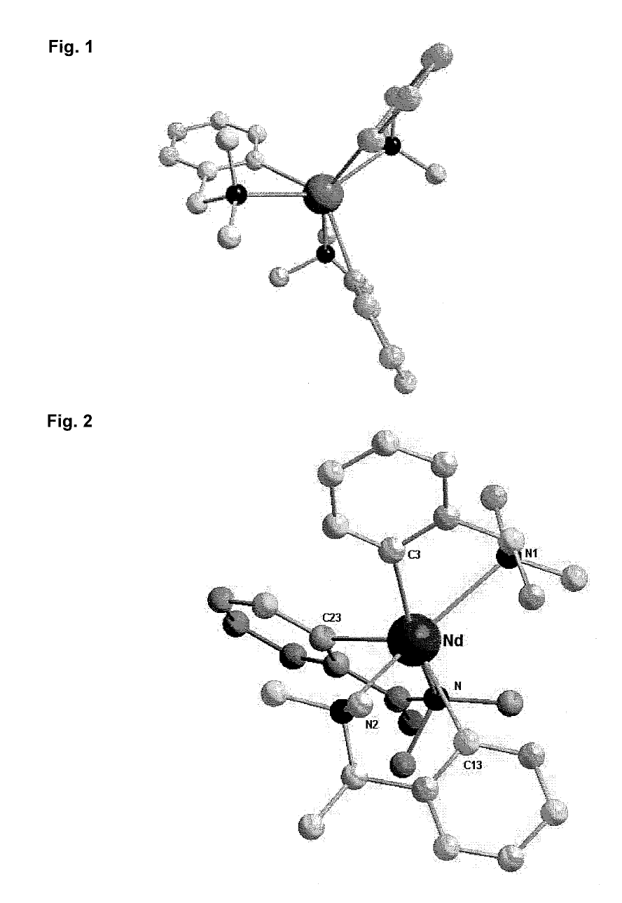

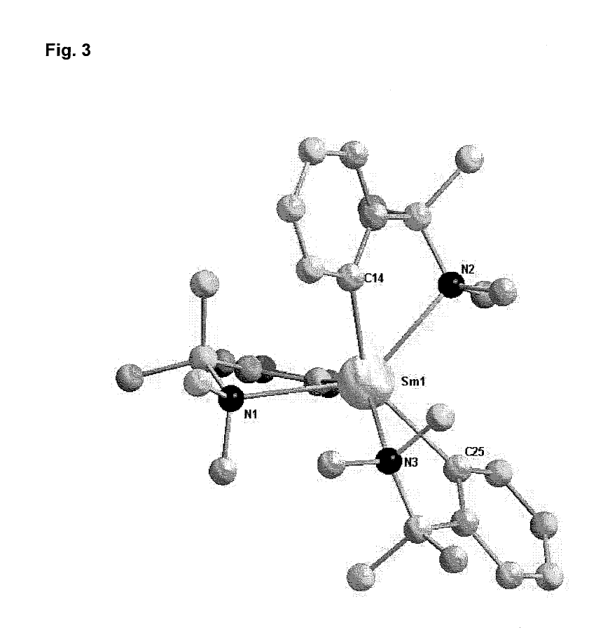

### Structure of [Y(C₆H₄CH₂N(CH₃)₂)₃],

monoclinic, C 1 2/c 1, wR2=0.1048, R1=0.0415

FIG. 2

### Structure of [Nd(C₆H₄CH(CH₃)N(CH₃)₂)₃]

Orthorhombic, P 2₁ 2₁ 2₁, Z=4, wR2=0.0699, R1=0.0291

FIG. 3

### Structure of [Sm(C₆H₄C(CH₃)₂N(CH₃)₂)₃]

Monoclinic, P 2₁/c, Z=4, wR2=0.0522, R1=0.0332

1. Homoleptic complexes according to formula (I): 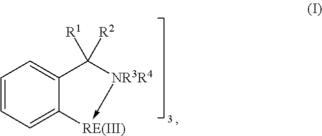
wherein
RE represents a rare-earth metal selected from Sc, Y, La, Ce, Pr, Nd, Pm, Sm, Eu, Gd, Tb, Dy, Ho, Er, Tm, Yb, Lu,
R¹ and R² are selected, independent of one another, from hydrogen, a linear or branched alkyl group with 1 to 10 carbon atoms, or an aryl group
or
R¹ and R² together represent 1,ω-alkyldiyl group, selected from 1,4-butandiyl or 1,5-pentandiyl,
R³ and R⁴ are selected, independent of one another, from a linear or branched alkyl group with 1 to 10 carbon atoms, an aryl group or a trialkylsilyl group —SiR⁵, wherein R⁵ represents a linear or branched alkyl group with 1 to 10 carbon atoms,
and wherein
at least one of both residues R¹ and R² is a group different from hydrogen.

2. Homoleptic complexes according to claim 1, wherein R¹ and R² are selected, independently of one another, from an unbranched or branched alkyl group with 1 to 10 carbon atoms or an aryl group.

3. Homoleptic complexes according to claim 1, wherein R¹ and R² together stand for 1,ω-alkyldiyl group, selected from 1,4-butandiyl or 1,5-pentandiyl.

4. Method for the synthesis of the complexes according to the present invention, comprising the steps:
addition of 3 equivalents of the ortho-lithiated aryl ligand to a suspension of 1 equivalent of the anhydrous RE halide in an absolute ether at room temperature and under inert gas atmosphere,
stirring for 1 hour,
isolation and purification of the homoleptic complex according to the present invention.

5. Use of the complexes according to claim 1 as catalysts for the hydroamination of olefins.

6. Use of the complexes according to claim 2 as catalysts for the hydroamination of olefins.

7. Use of the complexes according to claim 3 as catalysts for the hydroamination of olefins.
